(19) United States
(12) Patent Application Publication
(10) Pub. No.: US 2006/0011210 A1
(43) Pub. Date: Jan. 19, 2006

(54) Method and device for cleaning teeth

(76) Inventor: Basia Kaminski, Woodstock, NY (US)

Correspondence Address: John Maier, III, 660 Aaron Court, Kingston, NY, 12401, US

(21) Appl. No.: 10/893,097

(22) Filed: Jul. 16, 2004

(51) Int. Cl. A61C 15/00

(52) U.S. Cl. 132/321

(57) ABSTRACT

A device and a device are disclosed for cleaning the teeth. The device includes a plurality of tubes, having three different diameters. The tubes are retainedwith a container. The three different sizes include a small, medium anda large diameter tube. To clean a tooth, a tube of appropriate size for the tooth to be cleaned uis selectedand placed over the tooth so as to engage the tooth. The tube is twisted and forced over the tooth to engage the gum and is then twisted. The twisting tube thereby cleans the tooth and massages the gum. The process is repeated, always using a tube o appropriate size for the tooth to be cleaned. T6he tubes may be cleaned and reused and are disposable when no longer usable.

### BACKGROUND OF THE INVENTION

1. Field of the Invention

The field of the invention is a personal dental care device and a method for using the device.

2. Description of Related Art

Currently, in order to cleanse the teeth and fully stimulate the gums, at least two items are needed: namely a toothbrush with bristles which cleans the teeth, and dental floss which stimulates and cleans the gums. Toothpaste or sodium bicarbonate or another foaming or freshening agent are a frequently used as a third item for cleaning the teeth and mouth, many people also rinse the mouth with a mouthwash.

In general, this system of cleaning the teeth, gums and mouth is both convenient and effective while the user is at home. However, when traveling, it requires that the user carry at least a toothbrush and dental floss along; usually, travelers also carry toothpaste. There is a need for a simple tooth cleaning system that does not require the traveler to carry two or three separate items. Also, a simple device is needed to clean between the teth and stimulate the gums without the awkwardness of using dental floss.

### OBJECTS

The objects of this invention are to provide a device and method for cleaning teeth and the gums as follows:

1. A device that is inexpensive and durable.

2. A device that can be readily carried by a person when traveling.

3. A device that can be easily used when traveling.

4. A device that can be reused and is also readily disposable.

5. A method that is simple and convenient when traveling.

### BRIEF SUMMARY OF THE INVENTION

The present invention comprises a set of tubes of substantially equal length but of several different diameters to accommodate the several different-sized teeth in the mouth. The user slides a tube over a tooth; by twisting the tube as it covers the tooth, the user cleans the tooth, especially the space between adjacent teeth, and stimulates the surrounding gum tissue.

### BRIEF DESCRIPTION OF THE DRAWINGS

FIG. 1 shows a container of teeth-cleaning tubes with three distinct sizes.

FIG. 2 shows the positioning of a teeth-cleaning tube on an upper incisor.

### DETAILED DESCRIPTION OF THE INVENTION

The present invention teaches a device for cleaning teeth and stimulating gums and a method for using such a device.

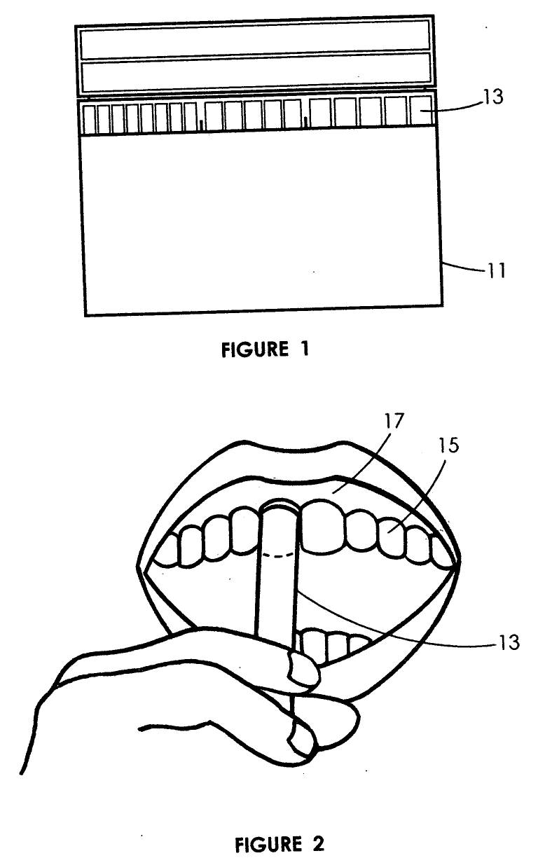

A container 11 of several tubes 13 is provided, as shown in FIG. 1. Each tube 13 is sized to fit around a tooth 15 of compatible size tubes 13. Preferably, a container 11 has tubes 13 of three different diameters. However, a greater or lesser selection of tube diameters may be provided in other embodiments. The tubes 13 may or may not be impregnated with an oral dentrifice or freshener.

Each tube 13 is comprised of a material with enough tensile strength to withstand insertion between closely spaced teeth 15, and the twisting of the tube13 between the adjacent teeth 15. The tubes 13 are of generally equal length, ranging from one and a half inches to three inches. The preferred length of the tubes is one and one quarter inches. This material may be plastic, stiff paper-based material or other material suitable for the purpose. It is essential that no tube break off between the teeth 15.

The tubes have a wall thickness which is virtually so small as not to be easily measured. The nominal diameter of the tubes is substantially as follows:

| TUBE TYPE | DIAMETER |
|---|---|
| Small | 0.231 inches |
| Medium | 0.254 inches |
| Large | 0.294 inches |

To use the device, a tube 13 of appropriate size for the tooth 15 to be cleaned is removed from the container 11. The smaller diameter tubes 13 fit the incisors and canines. The medium diameter tubes fit the canines and premolars. The largest diameter tubes 13 fit the molars and wisdom teeth. The tube 13 is then placed around the tooth 15 such that the tube 13 touches the adjacent gum tissue, as shown in FIG. 2. The tube 13 is then twisted back aend forth in a circular motion so that the tube 13 rotates around the tooth, cleaning the tooth 15 and massaging the gum 17 simultaneously. The tube 13 is then pulled from the cleaned tooth 15, and is either disposed of or returned to the container 11.

This disclosure teaches several embodiments of the invention, but it is not intended to limit the invention to the embodiments taught herein. The invention is intended to encompass all embodiments that fall within the spirit of the invention.

1. A tooth-cleaning device comprising:
a set of tubes of various diameters and substantially equal length to accommodate different sized teeth for cleaning the teeth; and
a container enclosing several of said tubes.

2. A tooth-cleaning device according to claim 1 wherein the tubes have three distinct diameters.

3. A tooth-cleaning device according to claim 1 wherein the tubes are composed of a material of sufficient strength to withstand insertion between adjacent teeth.

4. A tooth-cleaning device according to claim 1 wherein the material is sufficiently flexible to mold itself to a tooth as it moves around the tooth.

5. A tooth -cleaning device according to claim 1 wherein the tubes are composed of a material of sufficient strength to withstand insertion between adjacent teeth and is sufficiently flexible to mold itself to a tooth as it move around the tooth.

6. A tooth-cleaning device according to claim 1 wherein the material is a plastic which is sturdy enough to withstand insertion between two adjacent teeth and is also flexible enough to fit itself around differently shaped teeth.

7. A tooth-cleaning device according to claim 1 wherein the material being composed of a stiff paper product having sufficient flexibility to accommodate differently shaped teeth during use.

8. A tooth-cleaning device according to claim 1 wherein the tubes are impregnated with an oral dentrifice for further cleansing of the teeth and freshening of the mouth.

9. A tooth-cleaning device according to claim 1 wherein the tubes are reusable and disposable.

10. A tooth-cleaning device for cleaning the teeth comprising:
a set of tubes of substantially equal length and having three separate diameters to accommodate different sized teeth, the tubes being composed of a material with enough tensile strength to withstand being inserted between teeth and twisted.

11. A tooth-cleaning device according to claim 10 wherein the tubes are composed of a plastic material.

12. A tooth-cleaning device according to claim 10 wherein the tubes are composed of a stiff paper.

13. A tooth-cleaning device according to claim 10 wherein the tubes are impregnated with an oral cleansing and freshening substance such as toothpaste or sodium bicarbonate.

14. A tooth cleaning device according to claim 10 wherein the tubes are reusable and disposable.

15. A method of using a tooth cleaning device comprising:
selecting the proper diameter of tube to use for the tooth to be cleaned;
removing the tube of appropriate diameter from a container;
pushing said tube over a tooth such that the tube engages the tooth and engages the surrounding gum tissue;
twisting the tube against the tooth and the surrounding gum tissue to clean the tooth and stimulate the gum; and
pulling the tube away from the tooth when when cleaning is completed.
